(19) United States
(12) Patent Application Publication
(10) Pub. No.: US 2008/0219599 A1
(43) Pub. Date: Sep. 11, 2008

(54) Universal Interface For Medical Imaging Receptors

(75) Inventors: Richard Hopkins, Temecula, CA (US); Oscar Khutoryansky, Liverpool, NY (US)

Correspondence Address: BOND, SCHOENECK & KING, PLLC, ONE LINCOLN CENTER, SYRACUSE, NY, 13202-1355, US

(73) Assignee: INFIMED, INC., Liverpool, NY (US)

(21) Appl. No.: 11/924,968

(22) Filed: Oct. 26, 2007

Related U.S. Application Data
(60) Provisional application No. 60/893,304, filed on Mar. 6, 2007.

(51) Int. Cl. G06K 9/20; H04N 5/225

(52) U.S. Cl. 382/312; 348/207.1; 348/E05.024

(57) ABSTRACT

The present invention provides interchangeable modules each of which is adapted to interface with at least one image receptor having predetermined physical interface parameters, including means for receiving image data from the at least one image receptor, processing means for converting the received image data into a converted, common format, and bus means for adapting to and communicating with a mother board. The interchangeable modules can be embodied in a plurality of daughter boards that are adapted for electrical connection to a mother board. Each daughter board can include the physical interface corresponding with the image receptor for which it has been programmed to receive data, with the physical interface being adapted for extending outwardly from a cabinet enclosing the daughter board and mother board.

### CLAIM OF PRIORITY

The present application claims priority to U.S. Provisional Patent Application Ser. No. 60/893,304, filed Mar. 6, 2007, the entirety of which is incorporated herein by reference.

### BACKGROUND OF THE INVENTION

The present invention relates generally to systems for capturing and processing image data from commercially available image receptors, and more specifically to such systems that are adapted to interface with a plurality of image receptors that have different interface parameters.

Image receptors used in the medical imaging industry include, for example, CMOS cameras, CCD cameras, and flat panel detectors (FPDs). Generally, these receptors are activated to receive radiation that is passed through a subject in order to record an image based upon the amount of absorbed radiation. The data generated by these image receptors is sent via a predetermined protocol to a data processing module which is programmed to receive the particularly formatted data. This processed data can then be communicated to a display unit, such as a CRT, and/or stored in memory for archiving and subsequent retrieval and viewing.

Each of the various types and even different versions of the same type of image receptors has a unique interface. Thus, image data processing machines are designed to work in conjunction with a particular receptor. Therefore, if an imaging center uses two or more different types of receptors (e.g., to capture different types or sizes of images), an equal number of image processing units will be required to interface with these receptors.

With digital imaging becoming more conventional, and with digital imaging receptors becoming more versatile and prevalent, it would be useful to have an image processor having the capacity to interface with a variety of the receptors. Different receptors have advantageous features for different examinations. For example, some of them are used only for static radiographic exposures, some others are used for the dynamic fluoroscopic applications, while some others show better results for cardiac studies, or others are better for the chest exams.

It is therefore a principal object and advantage of the present invention to provide an image data processing unit adapted to interface with two or more image receptors each having unique interface parameters.

It is another object and advantage of the present invention to provide an image data processing unit that is adaptable to being used with a variety of image receptors each having predetermined interface parameters.

It is still a further object and advantage of the preset invention to provide interchangeable image modules for interfacing with a variety of image receptors each of which has predetermined interface parameters.

It is yet an additional object and advantage of the present invention to provide a method for interfacing with a variety of image receptors each of which includes a predetermined interface format.

It is another object and advantage of the present invention to provide the ability to interface to a plurality of various receptors in order to service different examination rooms and/or different diagnostic modalities with a single imaging processing system equipped with a universal multi-sensor interface.

Other objects and advantages of the present invention will in art be obvious and in par appear hereinafter.

### SUMMARY OF THE INVENTION

In accordance with the foregoing objects and advantages, the present invention provides in one aspect interchangeable modules each of which is adapted to interface with at least one image receptor having predetermined physical interface parameters, comprising means for receiving image data from the at least one image receptor; processing means for converting the received image data into a converted, common format; and bus means for adapting to and communicating with a mother board. The interchangeable modules can be embodied in a plurality of daughter boards that are adapted for electrical connection to a mother board. Each daughter board can include the physical interface corresponding with the image receptor for which it has been programmed to receive data, with the physical interface being adapted for extending outwardly from a cabinet enclosing the daughter board and mother board.

In another aspect of the present invention, there is provided an image data processing system for interfacing with a plurality of image receptors each of which has a predetermined physical interface parameter, said system comprising interchangeable modules adapted for interconnection to at least one of the image receptors; and a dedicated image processor adapted to receive data from at least one of said interchangeable modules. The interchangeable modules are embodied by the daughter cards described hereinabove, while the dedicated image processor is embodied by a motherboard that receives data of a predetermined format.

Finally, another aspect of the invention provides a method for processing image data supplied from at least one image receptor, wherein the method comprises the steps of providing at least one interchangeable module for receiving the image data from the at least one image receptor, converting the image data into a common image data format, providing a dedicated image processor, and communicating the common image data format from the at least one interchangeable module to the dedicated image processor.

### BRIEF DESCRIPTION OF THE DRAWINGS

The present invention will be more fully understood and appreciated by reading the following detailed description in conjunction with the accompanying drawings, in which:

FIG. 1 is a high level block diagram of two versions of the present invention;

FIG. 2A is a plan view of a bus configured in accordance with a first version of the present invention;

FIG. 2B is a plan view of a bus configured in accordance with a second version of the present invention;

FIG. 3 is a side elevation representational schematic of the present invention; and

FIG. 4 is a high level flow chart of the present invention.

### DETAILED DESCRIPTION

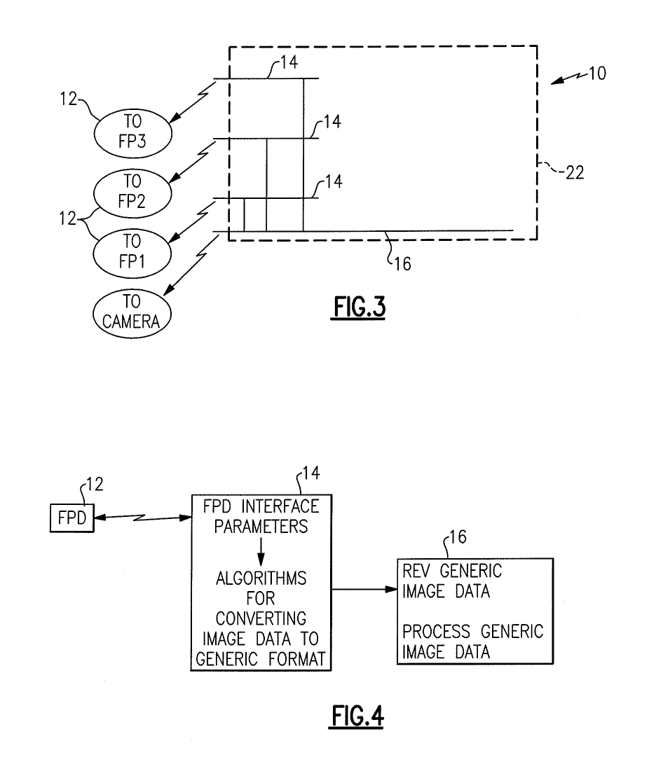

In accordance with the foregoing objects and advantages, the present invention provides a system, designated generally by reference numeral 10, for processing image data received from any one of a plurality of image receptors, such as flat panel displays (FPDs) 12 (see FIGS. 3 and 4). It should be understood that system 10 can be used in combination with different types of image receptors, such as the FPDs in the preferred embodiments, but also CMOS cameras, (CMOS being one variety of FPDs), CCD cameras, and other known types of digital image receptors.

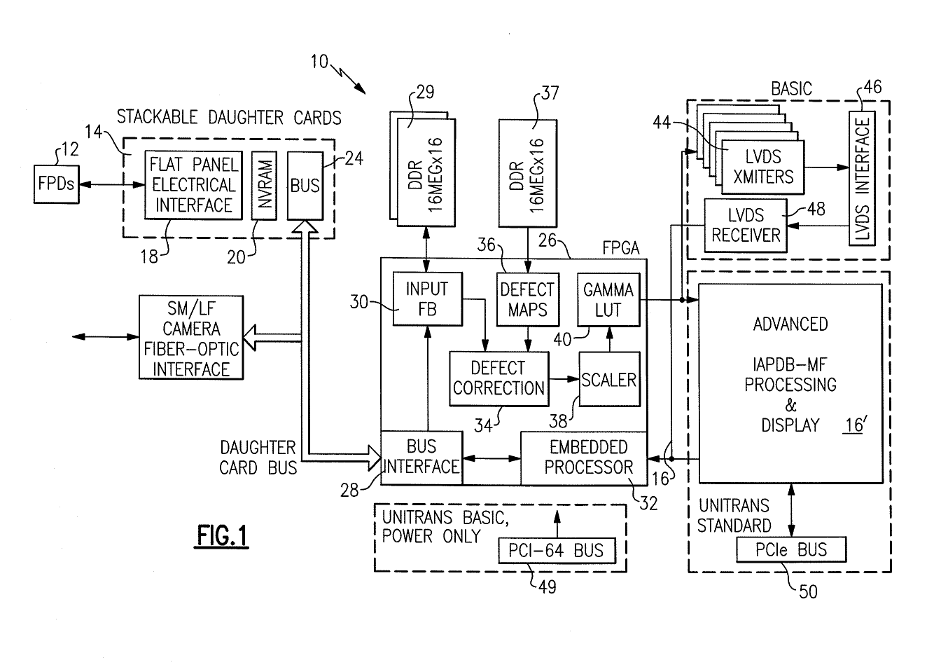

With reference to FIG. 1, system 10 generally comprises a plurality of daughter cards 14 that are stackable on a motherboard 16 (see FIG. 4). Each daughter card 14 will include an interface 18 that is specific to a particular type of receptor 12 (e.g., in FIG. 3, the three stacked daughter boards 14 are respectively interfaced to different FPDs 1, 2 and 3.) In addition, daughter cards 14 include memory 20, such as a non-volatile random access memory. Daughter boards 14 are configured to both request and receive data from the receptor 12 to which it is interfaced. Interfaces 18 are configured to extend outside of a cabinet 22 that houses the components of system 10. It should be noted that the FPD could be as simple as a passive cross bridge between individual sensor and a standard bus.

Each daughter card 14 communicates over a bus 24 with a FPGA 26 that includes a bus interface 28. On the mother board, FPGA 26 further includes an input frame buffer 30 that receives data from bus interface 28 (and that interfaces with a memory 29, such as a double data rate RAM (DDR RAM)), an embedded processor 32 that synchs with bus interface 28, a series of support functions, including, for example, defect correction algorithms 34 that receives image data from frame buffer 30 and defect data from a defect map 36 (that receives its data from a memory, such as a DDR RAM) 37, a Scaler 38 that scales image data received from defect correction algorithms 34, and a Gamma look up table 40 if needed, all of which combine to convert the image data to a generic format regardless of which receptor 12 originated the data. Please note, that Mother Board border started at Daughter Card Bus 24 on FIG. 1. Generic data from FPGA 26 (gamma look up table 40) is transmitted to a mother board 16 which processes the image data. In the basic embodiment of the present invention, low voltage differential signaling (LVDS) transmitters 44, a LVDS interface 46, and LVDS receivers 48 are utilized to transmit the data at high rates of speed. Other data transmission standards could also be used. In a more advanced version of the present invention, data from FPGA 26 is sent directly to the mother board 16′. It is preferred that the mother board has all image processing and manipulation power and communicates to the host (system 10) through PCIe bus.

In addition to stackable daughter cards 14, system 10 includes an interface to a different type of receptor, such as a fiber optic interface for a camera. In the basic version, power is supplied to daughter cards 14 via a dedicated peripheral component interface bus 49 (e.g., a PCI-64 bus,) while in the advanced version power and data communication are supplied from mother board 16′ with a PCI express (or PCIe) bus 50.

In essence, daughter cards 14 will convert commands from the image processor into the communications format required by receptors 12. The list of commands can be expanded as needed, and can include (but not limited to), for example:
Initiate single image capture
Terminate single image capture
Read image from receptor and transfer to mother board
Start continuous capture with automatic image transfer
Set frame rate (e.g., 30 fps, 15 fps, 10 fps, etc.)
Select readout region and resolution (with pixel binning)
Set panel sensitivity
Enable or disable low power standby mode
Diagnostics
   Status LED indicators for each power supply
   Power-on diagnostics with pass-fail LED indicator
   Mode LED indicators
   Internal test pattern generator
   Remote diagnostics for receptors and other components
   Remote download of firmware for FPGA and microprocessor
Read status and error messages
Start defect map calibration procedure
Read or write pixel defect map
Set Gamma look up table
Anti-vignetting coefficients (e.g., to correct underexposure in corners)
Define field of view

Defect correction will include stitching required for sub-panel mosaics like the Thales large format panel. The Thales panel is composed of four smaller panels with seams between them that need to be filled in. The defect map 36 is stored in non-volatile memory on each daughter board 14, and is calculated in the host and downloaded through the system to the non-volatile memory 20.

The raw image data from receptors 12 will be converted into a format selected by the host. The output image format can be a sub-region of the original image, and may include pixel binning to reduce resolution. The bit depth will also be adjusted as selected by the host. If necessary, typical 16-bit or 14-bit depth of an original image will be converted to 10-bit or 12-bit using look up table 40.

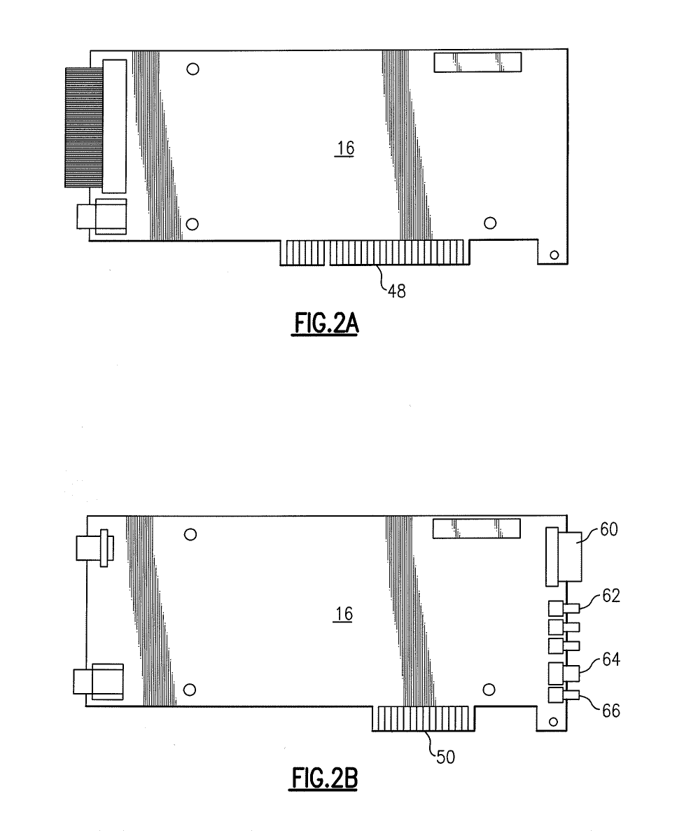

With reference to FIG. 2A, the basic version of the present invention is illustrated. An interface to convert a signal from LVDS to that appropriate for the image acquisition board 16 is provided, as is a second interface that does not need conversion, such as the fiber optic interface for a camera. Daughter cards can be mounted transversely across the mother board 16, and a PCI-64 bus 49 is provided to supply power to the daughter cards 14.

With reference to FIG. 2B, a predetermined interface such as an RJ45, as well as a fiber optic interface are provided, with daughter cards 14 being connected transversely across board 16′ and in stacked relation to one another. A PCIe 50 interface is provided, as are digital video interface 60 for receiving digital video data, and a DVI-I 62 interface to output either digital or analog video. Also, S-video and NTSC/PAL interfaces 64, 66 are provided.

What is claimed is:

1. Interchangeable modules each of which is adapted to interface with at least one image receptor having predetermined physical interface parameters, comprising:
means for receiving image data from the at least one image receptor;
means for converting said received image data into a converted, common format; and
means for adapting to and communicating with a mother board.

2. An image data processing system for interfacing with a plurality of image receptors each of which has a predetermined physical interface parameter, said system comprising:
interchangeable modules adapted for interconnection to at least one of the image receptors; and
a dedicated image processor adapted to receive data from at least one of said interchangeable modules.

3. A method for processing image data supplied from at least one image receptor, said method comprising the steps of:
providing at least one interchangeable module for receiving the image data from the at least one image receptor;
converting said image data into a common image data format;
providing a dedicated image processor; and
communicating said common image data format from said at least one interchangeable module to said dedicated image processor.
